(19) United States
(12) Patent Application Publication
(10) Pub. No.: US 2026/0179299 A1
(43) Pub. Date: Jun. 25, 2026

(54) FRAME INTERPOLATION FOR MOTION GRAPHICS

(71) Applicant: Adobe Inc., San Jose, CA (US)

(72) Inventors: Kazi Rubaiat Habib, Seattle, WA (US); Wilmot Wei-Mau Li, Seattle, WA (US); Valerie Lina Head, Pittsburgh, PA (US); Tomasz Artur Opasinski, Tujunga, CA (US); Timothy Richard Langlois, Seattle, WA (US); Tidjane Tall, Toronto (CA); Seth John Walker, Oakland, CA (US); Jakub Fiser, Milton Keynes (GB); Brooke Hopper, Berkeley, CA (US); Daniel Max Kaufman, Seattle, WA (US)

(73) Assignee: Adobe Inc., San Jose, CA (US)

(21) Appl. No.: 18/990,216

(22) Filed: Dec. 20, 2024

Related U.S. Application Data
(60) Provisional application No. 63/706,530, filed on Oct. 11, 2024.

(51) Int. Cl. G06T 13/80; G06T 3/18; G06T 7/73

(52) U.S. Cl. CPC G06T 13/80; G06T 3/18; G06T 7/73; G06T 2200/24

(57) ABSTRACT

In at least one implementation of systems for frame interpolation of motion graphics, a computing device implements a graphics module to receive inputs including a motion effect and a description of a digital artwork that includes at least one object. The graphics module determines a path for the motion effect. Based on the motion effect, the graphics module generates an animation sequence of the at least one object in the digital artwork across multiple frames along the path. The graphics module then outputs a digital animation of the digital artwork via a user interface. The digital animation uses the animation sequence to guide the movement of at least one object in multiple frames.

### CROSS-REFERENCE TO RELATED APPLICATION

This application claims priority to U.S. Provisional Patent Application No. 63/706,530, filed Oct. 11, 2024, and entitled “FRAME INTERPOLATION FOR MOTION GRAPHICS,” the content of which is incorporated herein by reference in its entirety.

### BACKGROUND

Applications for adding motion to and transitions between digital artwork, such as icons, text, and illustrations, often include large sets of editing controls with complicated settings to add motion or transitions to the artwork. For example, conventional techniques for applying transition effects from one artwork to another make it difficult to control the motion and mass transfer of the artworks during the transition or frame-by-frame. Similarly, adding introductory motion effects to static artwork (e.g., a logo that spins and increases in size as it comes into focus) is time-consuming and challenging, even for experienced graphic designers.

### SUMMARY

Techniques and systems are described for frame interpolation of motion graphics. In an example, a computing device implements a graphics system to detect objects depicted in a digital artwork that is displayed in a user interface of an application for editing digital content. Input data is received that includes a motion effect for the objects. The graphics system determines a path for the motion effect.

In one example, the input includes a first and second digital artwork, and the motion effect includes an interpolation from the first digital artwork to the second digital artwork. A user defines the interpolation path via the user interface as a correspondence between one or more points on the first and second digital artworks.

Based on the motion effect, the graphics system generates an animation sequence of the objects across multiple frames along the path. Continuing the example above, the animation sequence includes adding secondary dynamics to the objects using physical laws of mechanics. In this way, the animation sequence continues the kinematic motion of the interpolation frames until the objects or implicit surfaces thereof come to rest. Digital animation of the digital artwork using the animation sequence is then output via a user interface.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of an environment in an example implementation that is operable to employ digital systems and techniques for frame interpolation of motion graphics as described herein.

FIG. 2 depicts a system in an example implementation showing operation of a graphics module for frame interpolation of motion graphics.

FIG. 3 illustrates frames of an example of frame interpolation of an introductory motion graphic.

FIG. 4 illustrates frames of an example of frame interpolation of a transition motion graphic between two digital artworks.

FIG. 5 is a flow diagram depicting a procedure in an example implementation for frame interpolation of motion graphics.

FIG. 6 illustrates an example system that includes an example computing device that is representative of one or more computing systems and/or devices for implementing the various techniques described herein.

### DETAILED DESCRIPTION

### Overview

Static digital artwork, such as icons, logos, text, illustrations, and various combinations thereof, is editable using an application for editing digital content, for example, by adjusting the settings of editing controls of the application to change the visual appearance of the digital artwork. Examples of editing controls include color, size, fill pattern, etc. Some applications also provide controls for adding or editing motion effects applied to static digital artwork. These motion effects include introductory or outgoing motion effects for digital artworks or transition effects from one artwork to another. Conventional applications for applying motion effects to digital artworks are complex, resulting in difficult and time-consuming procedures to add a user's desired motion effects.

In contrast, the described techniques and systems for frame interpolations of motion graphics enable users to rapidly add motion to their static digital artworks by interpolating between different artworks or using template or preset motion effects to add introductory or outgoing effects. Unlike conventional approaches, the described techniques facilitate creative control and expressiveness by allowing users to input path sketches to guide and control artwork interpolation. Similarly, introductory and outgoing motion templates are made available to allow users to quickly create and experiment with distinct, stylized animations of their static artwork. The described systems analyze the user's digital artwork to adapt each motion template to the unique characteristics of each artwork. In addition, a user interface is provided to give users interactive control of the physics and timing of the added motion effects to facilitate fine-tuning and detailed dynamics.

For example, a user generates an image of a coffee cup for a digital brochure related to a new café. To add an introductory motion effect to the brochure, the user selects a swirl-in effect from a list of present introductory effects. The swirl-in effect starts with a small dot that expands into the volume of the coffee cup artwork as it swirls in a circle. The described system provides editing controls that allow the user to iterate different settings of this effect, including the color of the dot, its fill pattern, the size of the circle path, the speed of the swirl motion, and the transition rate from a dot to a coffee cup. The user interface also allows the user to iterate between different introductory effects quickly. In this example, the user edits the settings so that the swirl effects mimic cream being added to coffee.

In the following discussion, an example environment is first described that employs examples of techniques described herein. Example procedures are also described which are performable in the example environment and other environments. Consequently, performance of the example procedures is not limited to the example environment and the example environment is not limited to performance of the example procedures.

### Example Environment

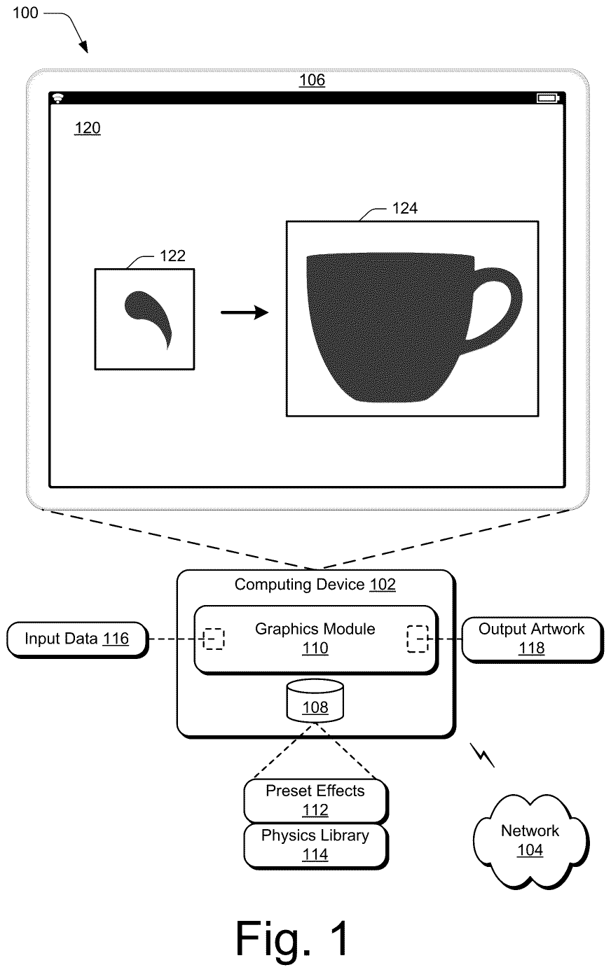

FIG. 1 is an illustration of an environment 100 in an example implementation that is operable to employ digital systems and techniques for frame interpolation of motion graphics as described herein. The illustrated environment 100 includes a computing device 102 connected to a network 104. The computing device 102 is configurable as a desktop computer, a laptop computer, a mobile device (e.g., assuming a handheld configuration such as a tablet or mobile phone), and so forth. Thus, the computing device 102 is capable of ranging from a full-resource device with substantial memory and processor resources (e.g., personal computers and game consoles) to a low-resource device with limited memory and/or processing resources (e.g., mobile devices). In some examples, the computing device 102 is representative of a plurality of different devices, such as multiple servers utilized to perform operations “in the cloud.”

The illustrated environment 100 also includes a display device 106 that is communicatively coupled to the computing device 102 via a wired or wireless connection. Various device configurations are usable to implement the computing device 102 and/or the display device 106. The computing device 102 includes a storage device 108 and a graphics module 110. The storage device 108 is illustrated to include preset effects 112 and a physics library.

For example, preset effects 112 include presets for adding motion graphics to static digital artworks. Each preset effect is a group of pre-defined motion effects that can be used to apply a particular motion feature to a digital artwork or an object depicted in the digital artwork. Examples of preset effects 112 include a swirling in effect, kersplash effect (e.g., a water drop landing in a puddle), pop in effect, bouncing-ball effect, starburst effect, and others.

The physics library 114 includes kinematic equations, properties, and relationships, allowing users to model secondary dynamics and follow through to the resulting motion introduced by either a preset effect 112 or an interpolation between artworks. The graphics module 110 utilizes a physics engine to model dynamics based on the physics library 114 and simulate the artwork(s) as real-world objects, with adjustable properties like friction, density, and stiffness and global forces like gravity and wind.

The graphics module 110 is illustrated as having, receiving, and/or transmitting input data 116. The input data includes a static digital artwork of text, icons, images, logos, and other digital content. For example, the input data 116 in the illustrated environment 100 is a coffee cup 124. Input data 116 also describes user interactions in a user interface 120 for generating and applying preset effects 112 or interpolation between multiple artworks. For example, user interface 120 is a user interface of the application for editing digital content, and the digital artwork is displayed in the user interface of the application.

In an example, a user interacts with an input device (e.g., a mouse, a stylus, a keyboard, a touchscreen, a microphone, etc.) relative to the user interface 120 to generate the input data 116 as describing motion or transition graphics to add to one or more digital artworks. In this example, the user manipulates the input device relative to the user interface 120 to select an object depicted in the digital artwork. After the selected motion graphics are added to the input digital artwork, the graphics module presents output artwork 118 with the motion graphics to the user via the user interface 120.

In order to facilitate generating and applying motion graphics to a wide variety of shapes, the graphics module 110 utilizes signed distance fields (SDF) to represent shapes in the digital artworks of the input data 116. SDF techniques provide a flexible and tunable memory footprint that allows the graphics module 110 to add motion graphics and interpolate between shapes of arbitrary topologies. In addition, SDF techniques provide an efficient approach for processing various shapes, including procedural and image-based shapes.

Consider an example in which the user interacts with the input device relative to the user interface 120 to create, upload, import, or otherwise generate a digital artwork of a coffee cup 124. The user also interacts with the user interface 120 to select from a swirl-in effect 122 from a list of preset effects 112. The list of preset effects 112 is displayed as selectable icons in the user interface 120 in one implementation. In another implementation, the user interface 120 includes a menu or pop-up window that provides a name and description of each preset effect 112.

Upon receiving the input data 116 that includes the swirl-in effect 122 and the coffee cup 124, the graphics module 110 generates output artwork that illustrates a small dot that swirls in a circle pattern until it fills out to the shape of the coffee cup 124. In at least one implementation, the user interface 120 associated with the graphics module 110 provides frame-by-frame representations and control of the output artwork 118 so the user can easily control or fine-tune different aspects of the motion effect or artwork therein. For example, the user interface 120 allows the user to change the color, size, speed, growth rate, and number of rotations of the swirl-in effect 122 and the coffee cup 124.

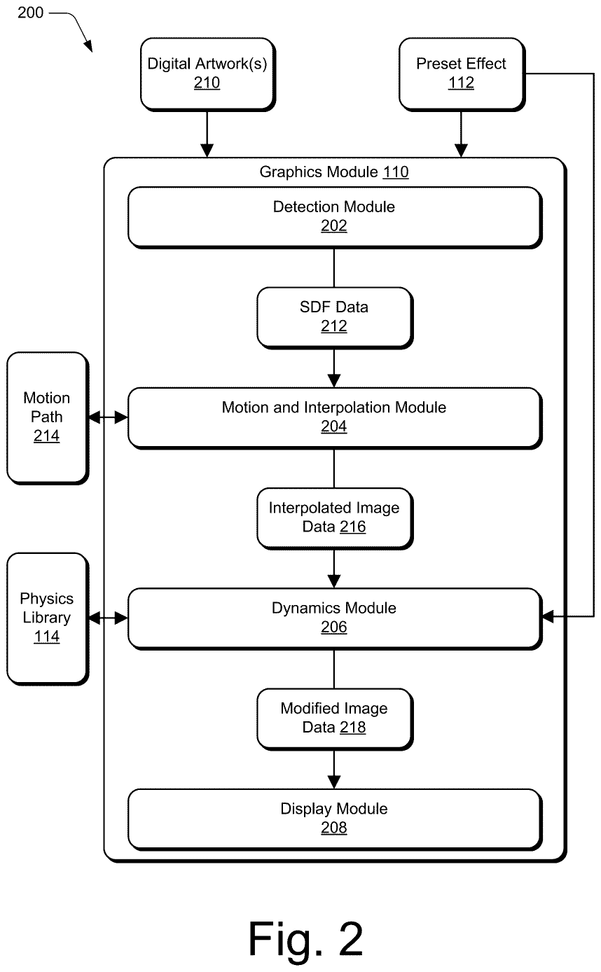

FIG. 2 depicts a system 200 in an example implementation showing operation of a graphics module 110 for frame interpolation of motion graphics. The graphics module 110 is illustrated to include a detection module 202, a motion and interpolation module 204, a dynamics module 206, and a display module 208. The graphics module 110 receives the input data 116 which describes or includes one or more digital artworks 210 displayed in an application's user interface for editing digital content. The graphics module 110 also receives the user's selection of a preset effect 112 which describes a particular motion effect to apply to the digital artworks 210.

The graphics module 110 has, receives, and/or transmits the preset effects 112 that describes presets for editing digital artworks 210. In an example, each of the presets described by the preset effects 112 includes pre-defined settings of adjustable editing controls of the application for editing digital content that are usable to apply a particular visual feature or motion to a digital artwork 210 or an object depicted in the digital artwork 210. In one example, each preset described by the preset effects 112 is an extensible metadata platform document that encodes the pre-defined settings of the adjustable editing controls.

The detection module 202 receives the digital artwork 210 and processes the image data of the digital artwork 210 to generate SDF data 212. The graphics module 110 utilizes SDFs to represent shapes within the digital artworks 210. In particular, the detection module 202 computes the SDF data 212 for the digital artworks 210 and stores it in a two-dimensional (2D) texture. Signed distances represent the geometry of shapes using a mathematical function. Instead of defining a shape with a set of polygons (e.g., triangles and squares), signed distances use a function that takes a point in 2D space as input and returns a value indicating the distance to the closest boundary of the shape. For example, each sampling point in the SDF data 212 represents the Euclidean distance from that point to the nearest point on the shape's boundary. The sign of the value indicates whether the point is inside (e.g., a negative value) or outside (e.g., a positive value) the shape's boundary. On the shape's boundary, the value is equal to zero.

The SDF data 212 includes a series of signed distances that form a 2D texture grid. Further discussion of computing or generating the SDF data 212 for one or more shapes in the digital artworks 210 is described in Pedro F. Felzenszwalb and Daniel P. Huttenlocher, “Distance Transforms of Sampled Functions,” in Theory of Computing, Vol. 8 (2012), pp. 415-428, the entirety of which is incorporated by reference herein. The shape is retrievable from the SDF data 212 by extracting the isocontour at the zero-level set. The detection module 202 generates the SDF data 212, which describes the processed digital artwork 210, and provides this SDF data 212 to the motion and interpolation module 204.

The motion and interpolation module 204 receives the SDF data 212 and the selected preset effect 112. In one implementation, the SDF data 212 is generated by the detection module 202 before or as the user selects the preset effect 112. The motion and interpolation module 204 uses the SDF data 212 of the input digital artwork 210 and any shapes associated with the preset effect 112. To generate the frames between a starting point and end point of the animated graphic motion, the motion and interpolation module 204 uses linear interpolation between two sets of SDF data by blending the distance values locally in each pixel of the 2D textures and then resolving the isocontour of the blended SDF data at the zero-level set.

In addition, the motion and interpolation module 204 may also receive a motion path 214 input by the user (e.g., as a sketched path entered using a mouse, stylus, or other user input) to guide the trajectory of the motion or interpolation generated by the graphics module 110. For example, the motion path 214 can specify the trajectory of corresponding points between two digital artworks 210 as the graphics module 110 interpolates from a first digital artwork to a second digital artwork. In other words, the warped or interpolated motion is not limited to a straight line, but the interpolation is user-adjustable to travel along unique paths from the first digital artwork to the second digital artwork.

To enable user-controlled motion paths 214, the motion and interpolation module 204 constructs a warping field from the motion path 214 to blend the SDF interpolation. Given the points that motion path 214 takes, the motion and interpolation module 204 constructs smooth warping fields that warp the points to the correct position at the corresponding time during the interpolation. The warping fields are built using thin-plate spline interpolation. In other implementations, other warping field approaches that follow the motion path 214 are used. In particular, the motion and interpolation module 204 warps the SDF data 212 of the input digital artwork 210 halfway between the two shapes, with the SDF shape interpolation occurring in this halfway space. Given a set of corresponding points between two shapes A and B, the motion and interpolation module 204 constructs two displacement warp functions w_{A} and w_{B}. The function w_{A} specifies what values to add to locations on shape A in order to warp it half-way to shape B, and the warping function w_{B} warps B half of the way to A. The interpolated image is then unwarped to obtain interpolated image data 216. Further discussion of warping between digital artworks is described in Greg Turk and James F. O'Brien, “Shape Transformation Using Variational Implicit Functions,” in Computer Graphics Proceedings, Annual Conference Series, 1999, pp. 335-342, the entirety of which is incorporated by reference herein. In one implementation, the motion and interpolation module 204 performs a two-level lookup to find the final sampling coordinates for both input SDF data 212, which are undistorted, instead of directly warping the SDF values. It is noted that the inverse warp textures are unchanged during the blend operation, but the forward warps are recomputed for each frame. The motion and interpolation module 204 provides the interpolated image data 216 to the dynamics module 206.

The dynamics module 206 receives the interpolated image data 216 and utilizes the physics library 114 to generate modified image data 218 to incorporate secondary dynamics and follow through to the resulting motion and/or interpolation. Given a sequence of frame interpolation images in the interpolated image data 216, the dynamics module 206 generates a triangle mesh of the final frame. From the last two frames of the interpolation sequence, the dynamics module 206 estimates the velocity of the shape's implicit surface. Implicit surfaces are the iso-contour of a smooth function. As the surface varies over time due to the interpolation or motion effects, the dynamics module 206 determines the tangential component of the velocities along the gradient of the implicit function (e.g., an estimation of the total velocity). Further discussion of estimating the implicit-surface velocity is given in Jos Stam and Ryan Schmidt, “On the Velocity of an Implicit Surface,” ACM Transactions on Graphics, 2011, the entirety of which is incorporated by reference herein.

A physics engine or library of the dynamics module 206 is initialized with the triangle mesh and the estimated velocities, running the motion of the shape(s) forward and generating additional frames. In this way, the dynamics module 206 allows the dynamics of the interpolated or created motion to seamlessly take over or continue at the end of a preset effect 112. The generated mesh of the additional frames matches the digital artwork tightly, and the estimated velocities ensure a smooth transition. The additional frames with the resultant motion are added to the interpolated image data 216 to generate the modified image data 218 until the implicit surfaces of the digital artwork reach a resting position. The display module 208 receives and processes the modified image data 218 to display the output artwork 118 in the user interface 120.

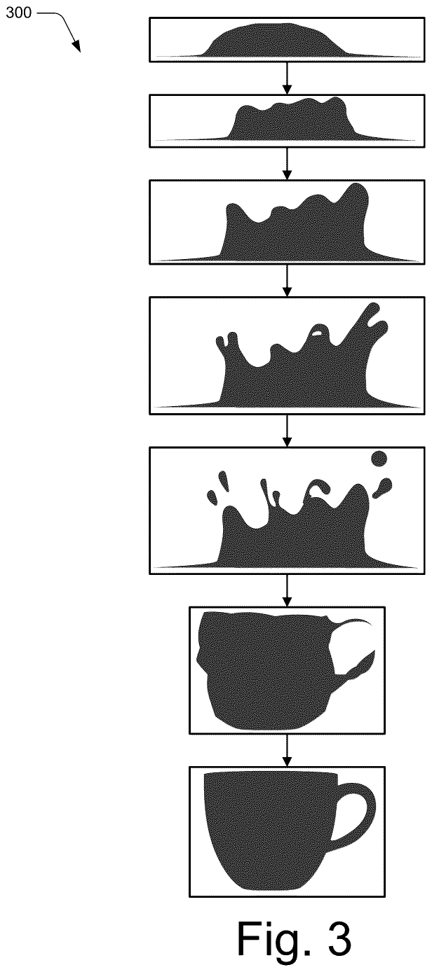

FIG. 3 illustrates frames of an example 300 of frame interpolation of an introductory motion graphic. In the illustrated example 300, a water drop falls onto a flat surface and splashes up. The splash continues until the water slowly fills into the shape of a coffee cup. In example 300, the digital artworks 210 include an initial water drop and the coffee cup design. In alternative implementations, the user can select the initial digital artwork to be a coffee bean, coffee maker pod, or another artwork. The preset effect 112 is a water-splash or kersplash effect that fills into the desired digital artwork.

A user interface 120 associated with the graphics module 110 provide various editable controls for the user. In one implementation, the user-adjustable controls include playback speed control, motion start and end points, motion path, assignment of the beginning and ending digital artworks, corner smoothing, fill colors, outline colors, outline thickness, fill pattern, and/or blending speed. As described above, the introductory effects are provided as a menu or list of preset effects 112 that are user-selectable, including a swirling in effect, kersplash effect (e.g., a water drop landing in a puddle), pop-in effect, bouncing-ball effect, starburst effect, and others. The preset effects 112 can also include outgoing effects to start from a user-designed digital artwork and fade out or disappear to another digital artwork or none at all.

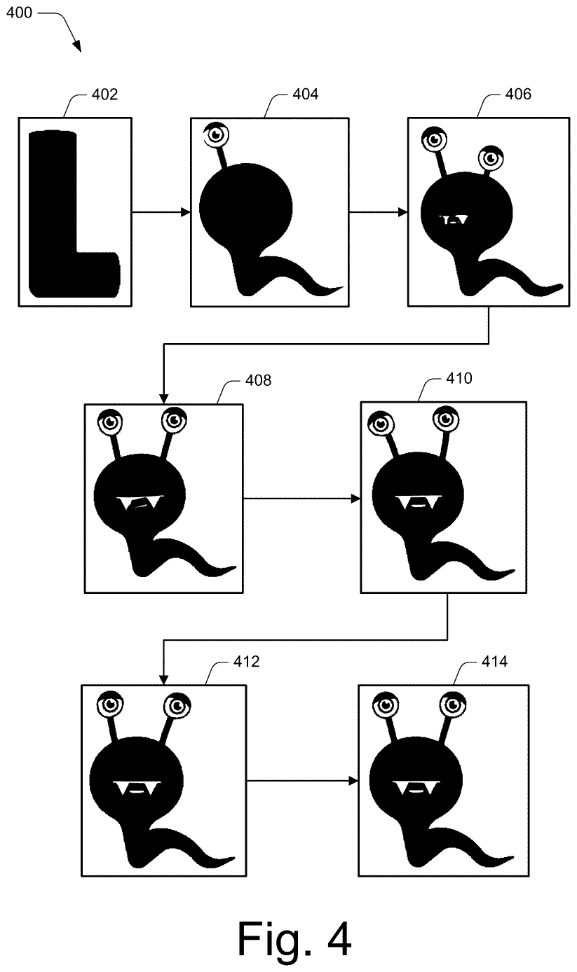

FIG. 4 illustrates frames of an example 400 of frame interpolation of a transition motion graphic between two digital artworks. In example 400, the motion graphics module 110 provides an interpolation between two digital artworks: the letter “L” and a slug-like creature that has a general L shape. The motion graphics module 110 also provides secondary dynamics to the animation sequence to continue the kinematic motion of the slug-like creature.

In frame 402, the animation sequence begins with the letter “L” digital artwork. The letter “L” transitions from its original shape into the general shape of the slug-like creature in frames 404 and 406. Each eye pops out from the creature's head during these interpolation frames and the mouth forms. In frame 408, both eyes have popped out, and the interpolation has transitioned to the second digital artwork (e.g., the slug-like creature). The graphics module 110 continues the animation sequence by adding secondary dynamics to the movement of the eyes and the creature's head to provide an effect that follows the laws of kinematic motion for the implicit surfaces of the slug-like creature in frames 410 and 412. In frame 414, the secondary dynamics have ceased, and the slug-like creature's features have come to rest as the second digital artwork. In this way, the graphics module 110 provides a more realistic and engaging animation sequence with an intuitive and uncomplicated user experience.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable individually, together, and/or combined in different ways. Thus, individual functionality, features, and concepts described in relation to different example environments, devices, components, figures, and procedures herein are usable in any suitable combinations and are not limited to the particular combinations represented by the enumerated examples in this description.

### Example Procedures

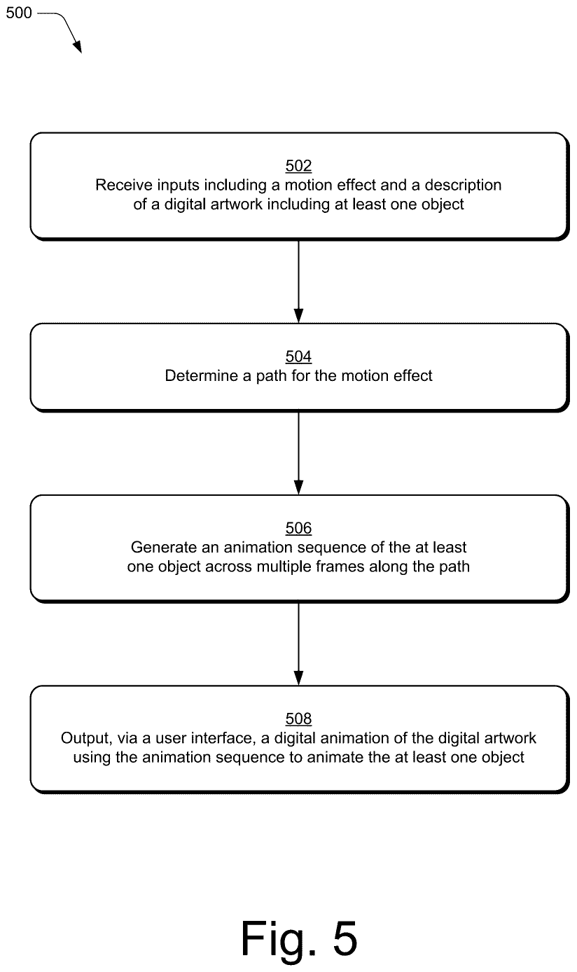

The following discussion describes techniques which are implementable utilizing the previously described systems and devices. Aspects of each of the procedures are implementable in hardware, firmware, software, or a combination thereof. The procedures are shown as a set of blocks that specify operations performed by one or more devices and are not necessarily limited to the orders shown for performing the operations by the respective blocks. In portions of the following discussion, reference is made to FIGS. 1-4. FIG. 5 is a flow diagram depicting a procedure in an example implementation for frame interpolation of motion graphics.

Inputs including a motion effect and a description of a digital artwork including at least one object are received (block 502). The computing device 102 implements the graphics module 110 to receive or detect the objects depicted in a digital artwork and receive a user-selected motion effect. A path for the motion effect is then determined (block 504). In one example, the input includes a first and second digital artwork and the motion effect includes an interpolation from the first digital artwork to the second digital artwork. A user defines the path for the interpolation via the user interface. The path can include a correspondence between one or more points on the first and second digital artworks to guide the interpolation. In another example, the input includes a single digital artwork and the motion effect includes an introductory motion effect or an outgoing motion effect selected from a list of preset motion effects.

Based on the motion effect, an animation sequence of the at least one object across multiple frames along the path is generated (block 506). In one implementation, the animation sequence is generated by determining initial SDF values for pixels associated with the object(s) in the digital artwork. Interpolated SDF values for the pixels are then determined for each frame of the multiple frames. The interpolated SDF values are obtained using warping fields on the initial SDF values. In particular, the interpolated SDF values an interpolation of the warped input fields:

$${SDF}_{I} = ( 1 - t ) {SDF}_{A} + t * {SDF}_{B}$$

where t is the interpolation time that ranges from 0 to 1 and SDF_{A} and SDF_{B} are the input SDF fields that have been warped to the intermediate space. The interpolated SDF values are then unwarped to obtain the final output. The animation sequence is then generated by unwarping the digital artwork across the multiple frames from the interpolated SDF values. In at least one implementation, the animation sequence includes adding secondary dynamics to the object using physical laws of mechanics. In this way, the animation sequence continues the kinematic motion of the interpolation frames until the object or implicit surfaces thereof come to rest. A digital animation of the digital artwork is then output via a user interface (block 508). The digital animation uses the animation sequence to animate the at least one object.

### Example System and Device

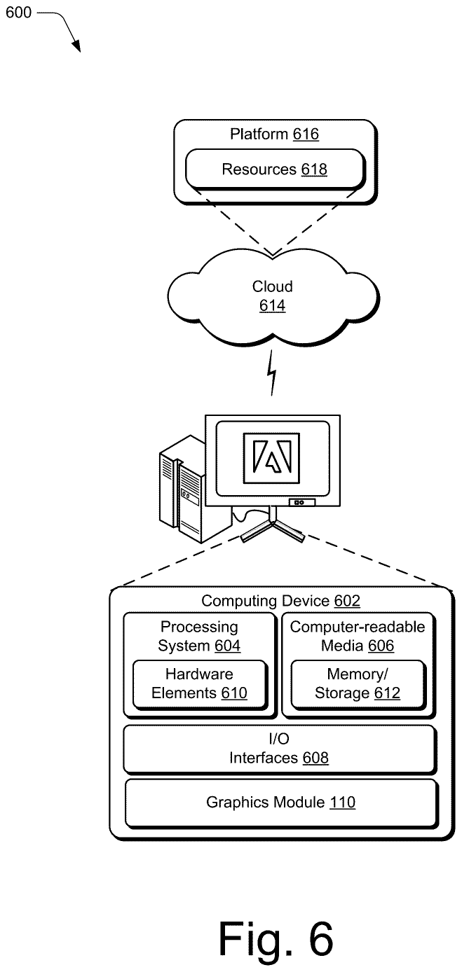

FIG. 6 illustrates an example system 600 that includes an example computing device that is representative of one or more computing systems and/or devices that are usable to implement the various techniques described herein. This is illustrated through inclusion of the graphics module 110. The computing device 602 includes, for example, a server of a service provider, a device associated with a client (e.g., a client device), an on-chip system, and/or any other suitable computing device or computing system.

The example computing device 602 as illustrated includes a processing system 604, one or more computer-readable media 606, and one or more I/O interfaces 608 that are communicatively coupled, one to another. Although not shown, the computing device 602 further includes a system bus or other data and command transfer system that couples the various components, one to another. For example, a system bus includes any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 604 is representative of functionality to perform one or more operations using hardware. Accordingly, the processing system 604 is illustrated as including hardware elements 610 that are configured as processors, functional blocks, and so forth. This includes example implementations in hardware as an application specific integrated circuit or other logic device formed using one or more semiconductors. The hardware elements 610 are not limited by the materials from which they are formed or the processing mechanisms employed therein. For example, processors are comprised of semiconductor(s) and/or transistors (e.g., electronic integrated circuits (ICs)). In such a context, processor-executable instructions are, for example, electronically-executable instructions.

The computer-readable media 606 is illustrated as including memory/storage 612. The memory/storage 612 represents memory/storage capacity associated with one or more computer-readable media. In one example, the memory/storage 612 includes volatile media (such as random access memory (RAM)) and/or nonvolatile media (such as read only memory (ROM), Flash memory, optical disks, magnetic disks, and so forth). In another example, the memory/storage 612 includes fixed media (e.g., RAM, ROM, a fixed hard drive, and so on) as well as removable media (e.g., Flash memory, a removable hard drive, an optical disc, and so forth). The computer-readable media 606 is configurable in a variety of other ways as further described below.

Input/output interface(s) 608 are representative of functionality to allow a user to enter commands and information to computing device 602, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which employs visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 602 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are implementable on a variety of commercial computing platforms having a variety of processors.

Implementations of the described modules and techniques are storable on or transmitted across some form of computer-readable media. For example, the computer-readable media includes a variety of media that is accessible to the computing device 602. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which are accessible to a computer.

“Computer-readable signal media” refers to a signal-bearing medium that is configured to transmit instructions to the hardware of the computing device 602, such as via a network. Signal media typically embodies computer-readable instructions, data structures, program modules, or other data in a modulated data signal, such as carrier waves, data signals, or another transport mechanism. Signal media also includes any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 610 and computer-readable media 606 are representative of modules, programmable device logic and/or fixed device logic implemented in a hardware form that is employable in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also employable to implement various techniques described herein. Accordingly, software, hardware, or executable modules are implementable as one or more instructions and/or logic embodied on some form of computer-readable storage media and/or by one or more hardware elements 610. For example, the computing device 602 is configured to implement particular instructions and/or functions corresponding to the software and/or hardware modules. Accordingly, implementation of a module that is executable by the computing device 602 as software is achieved at least partially in hardware, e.g., through use of computer-readable storage media and/or hardware elements 610 of the processing system 604. The instructions and/or functions are executable/operable by one or more articles of manufacture (for example, one or more computing devices 602 and/or processing systems 604) to implement techniques, modules, and examples described herein.

The techniques described herein are supportable by various configurations of the computing device 602 and are not limited to the specific examples of the techniques described herein. This functionality is also implementable entirely or partially through use of a distributed system, such as over a “cloud” 614 as described below.

The cloud 614 includes and/or is representative of a platform 616 for resources 618. The platform 616 abstracts underlying functionality of hardware (e.g., servers) and software resources of the cloud 614. For example, the resources 618 include applications and/or data that are utilized while computer processing is executed on servers that are remote from the computing device 602. In some examples, the resources 618 also include services provided over the Internet and/or through a subscriber network, such as a cellular or Wi-Fi network.

The platform 616 abstracts the resources 618 and functions to connect the computing device 602 with other computing devices. In some examples, the platform 616 also serves to abstract scaling of resources to provide a corresponding level of scale to encountered demand for the resources that are implemented via the platform. Accordingly, in an interconnected device embodiment, implementation of functionality described herein is distributable throughout the system 600. For example, the functionality is implementable in part on the computing device 602 as well as via the platform 616 that abstracts the functionality of the cloud 614.

Although implementations of systems for frame interpolation of motion graphics have been described in language specific to structural features and/or methods, it is to be understood that the appended claims are not necessarily limited to the specific features or methods described. Rather, the specific features and methods are disclosed as example implementations of systems for frame interpolation of motion graphics, and other equivalent features and methods are intended to be within the scope of the appended claims. Further, various different examples are described and it is to be appreciated that each described example is implementable independently or in connection with one or more other described examples.

What is claimed is:

1. A method comprising:
receiving, by a processing device, inputs including a motion effect and a description of a digital artwork including at least one object;
determining, by the processing device, a path for the motion effect;
generating, by the processing device, an animation sequence of the at least one object across multiple frames along the path; and
outputting, by the processing device via a user interface, a digital animation of the digital artwork using the animation sequence to animate the at least one object.

2. The method of claim 1, wherein:
the inputs include a first digital artwork and a second digital artwork; and
the motion effect includes an interpolation from the first digital artwork to the second digital artwork.

3. The method of claim 2, wherein the path for the interpolation is defined by a user input via the user interface.

4. The method of claim 3, wherein the path includes a correspondence between at least one first point on the first digital artwork and at least one second point on the second digital artwork, respectively, to guide the interpolation.

5. The method of claim 1, wherein the motion effect includes an introductory motion effect or an outgoing motion effect selected from a list of multiple preset motion effects.

6. The method of claim 1, wherein the user interface includes one or more user-adjustable controls for the animation sequence including at least one of a playback speed, a starting digital artwork, an ending digital artwork, corner smoothing, a fill color, a fill pattern, an outline color, an outline thickness, or a blending speed.

7. The method of claim 1, wherein the animation sequence is generated by:
determining, by the processing device, initial signed distance field (SDF) values for pixels associated with the at least one object of the digital artwork;
determining, by the processing device and using warping fields on the initial SDF values, interpolated SDF values for the pixels for each frame of the multiple frames; and
generating, by the processing device, the animation sequence across the multiple frames by unwarping the digital artwork.

8. The method of claim 7, wherein the interpolated SDF values using the warping fields are determined by using two-level lookup to find sampling coordinates for each interpolated SDF value.

9. The method of claim 1, wherein the animation sequence includes adding, using physical laws of mechanics, secondary dynamics to the at least one object.

10. The method of claim 9, wherein the secondary dynamics are added by:
generating a triangle mesh of a final frame of the animation sequence;
estimating, using last two frames of the multiple frames, a velocity of an implicit surface of the at least one object;
initializing a physics engine with the triangle mesh and the estimated velocity of the implicit surface; and
running the mechanics of the at implicit surface forward until the at least one object reaches a resting position.

11. A system comprising:
a memory component; and
one or more processing devices coupled to the memory component, the one or more processing devices to perform operations comprising:
receive inputs including a preset motion effect and a description of a digital artwork that includes at least one object;
generate, based on the preset motion effect, an animation sequence of the at least one object across multiple frames; and
output, via a user interface, a digital animation of the digital artwork using the animation sequence.

12. The system of claim 11, wherein the preset motion effect includes an introductory motion effect to animate an appearance of the at least one object or an outgoing motion effect to animate a disappearance of the at least one object.

13. The system of claim 11, wherein:
the inputs include a first digital artwork and a second digital artwork; and
the preset motion effect includes an interpolation from the first digital artwork to the second digital artwork, a path for the interpolation being defined by a user input via the user interface.

14. The system of claim 13, wherein the path includes a correspondence between at least one first point on the first digital artwork and at least one second point on the second digital artwork, respectively, to guide the interpolation.

15. The system of claim 13, wherein the path includes a user sketched line along which the interpolation travels from the first digital artwork to the second digital artwork.

16. The system of claim 11, wherein the user interface includes one or more user-adjustable controls for the animation sequence including at least one of a playback speed, a starting digital artwork, an ending digital artwork, corner smoothing, a fill color, a fill pattern, an outline color, an outline thickness, or a blending speed.

17. The system of claim 11, wherein the animation sequence is generated by:
determining initial signed distance field (SDF) values for pixels associated with the at least one object of the digital artwork;
determining, using warping fields on the initial SDF values, interpolated SDF values for the pixels for each frame of the multiple frames; and
generating the animation sequence across the multiple frames by unwarping the digital artwork.

18. The system of claim 17, wherein the interpolated SDF values using the warping fields are determined by using two-level lookup to find sampling coordinates for each interpolated SDF value.

19. The system of claim 11, wherein the animation sequence includes adding, using physical laws of mechanics, secondary dynamics to the at least one object by:
generating a triangle mesh of a final frame of the animation sequence;
estimating, using last two frames of the multiple frames, a velocity of an implicit surface of the at least one object;
initializing a physics engine with the triangle mesh and the estimated velocity of the implicit surface; and
running the mechanics of the at implicit surface forward until the at least one object reaches a resting position.

20. One or more computer-readable storage media comprising instructions stored thereon that, responsive to execution by a computing device, causes the computing device to perform operations including:
receive inputs including a motion effect and a description of a digital artwork including at least one object;
determine a path for the motion effect;
generate an animation sequence of the at least one object across multiple frames along the path; and
output, via a user interface, a digital animation of the digital artwork using the animation sequence to animate the at least one object.
